(19) United States
(12) Patent Application Publication
(10) Pub. No.: US 2010/0142362 A1
(43) Pub. Date: Jun. 10, 2010

(54) HIGH DENSITY OPTICAL DISK AND REPRODUCTION/TRACKING CONTROL METHOD

(76) Inventors: Kazuma Kurihara, Tsukuba-shi (JP); Yuzo Yamakawa, Tokyo (JP); Takashi Nakano, Tsukuba-shi (JP); Junji Tominaga, Tsukuba-shi (JP)

Correspondence Address: OSTROLENK FABER GERB & SOFFEN, 1180 AVENUE OF THE AMERICAS, NEW YORK, NY, 100368403, US

(21) Appl. No.: 12/088,216

(22) PCT Filed: Sep. 25, 2006
(86) PCT No.: PCT/JP2006/318998

§ 371 Date: Mar. 26, 2008

(30) Foreign Application Priority Data
Sep. 26, 2005 (JP) P2005-277002

(51) Int. Cl. G11B 7/24; G11B 20/00

(52) U.S. Cl. 369/275.4; 369/47.15; G9B/20; G9B/7

(57) ABSTRACT

When a method for increasing density by providing a tracking guide such as a land/groove and introducing a plurality of strings of super-resolution pits into one track thereof is applied to a reproduction-dedicated optical disk, there are problems in that the production cost is increased, the structure is complicated, and the space which can be used for a recording pits is narrowed because of the land/groove structure.

In the invention, a concept of group tracking is applied. One track is formed by a plurality of pit strings having a size not greater than the optical resolution limit in the radial direction and a size not less than or not greater than the optical resolution limit or only not greater than the optical resolution limit in the tangential direction. Reproduction of the super-resolution pit itself is performed by using a non-linear phenomenon generated locally, but, in tracking, a plurality of strings of pits are considered to be one track, and detection of the movement of a laser light for read out is realized by the method used for an existing optical disk by using a reflected light or a transmitted light from the optical disk.

### TECHNICAL FIELD

The present invention relates to densification in the radial direction of a super-resolution optical disk using a non-linear phenomenon.

### BACKGROUND ART

In order to achieve densification exceeding the optical resolution limit of an optical disk, reproduction techniques are reported which enhance one of the several prerecorded pits, which are located within a spot of readout laser light in the tangential direction of an optical disk and are not greater than the optical resolution limit, by optical characteristics or the like of a functional thin film added to the media (refer to non-patent documents 1 to 3, and patent documents 1 and 2 (patent document 2 is a counterpart patent of patent document 1)).

In order to maintain consistency with conventional optical disks, a conventional system is used for the methods of focusing and tracking control or the like to these optical disks. In the reproduction techniques, the resolution in the tangential direction increases, but the resolution in the radial direction is not improved as much (because the spot diameter does not reduce), and therefore when attempting densification of resolution not more than the optical diffraction limit also in the radial direction of an optical disk, it is difficult to densify the resolution with optical detection in the conventional tracking techniques.

Furthermore in these optical disk, since pits of a size not less than or not greater than the optical resolution limit are mixed, and also for the read out signal, the normal far field signal and the super-resolution signal are mixed. Therefore, even if the track pitch is simply narrowed, the signal crosstalk becomes significant, and implementation is difficult.

Therefore, as a method of improving densification in the radial direction of an optical disk, there is a report that on one track for a pre-grooved substrate of a conventional pit, many pits of only those not greater than the super-resolution limit are arranged in a plurality of strings to improve the density in the radial direction is improved (refer to non-patent document 4). According to the document, the plurality of pit strings are detected independently by adjusting the track offset.
Non-Patent Document 1: J. Tominaga et al.: Appl. Phys. Lett. 73, 2078 (1998)
Non-Patent Document 2: T. Kikukawa et al.: Appl. Phys. Lett. 81, 4697 (2002)
Non-Patent Document 3: D. Yoon et al.: Jpn. J. Appl. Phys. 43, 4945 (2004)
Non-Patent Document 4: J. Tominaga et al.: Jpn. J. Appl. Phys. 37, L1323 (1998)
Patent Document 1: Japanese Patent Application No. H 10-67883 (Japanese Unexamined Patent Application, First Publication No. H 11-250493)
Patent Document 2: U.S. Pat. No. 6,226,258

When a method for increasing density by providing a tracking guide such as a land/groove and introducing a plurality of strings of super-resolution pits into one track thereof is applied to a reproduction-dedicated optical disk, there are problems in that the production cost is increased, the structure is complicated, and the space which can be used for recording pits is narrowed because of the land/groove structure. Therefore, in the development of a high density disk in the true sense, it is desirable to implement densification in the radial direction of the optical disk to which a tracking method using the pre-recorded pits themselves similar to the existing reproduction-dedicated optical disk is available.

### DISCLOSURE OF INVENTION

In order to solve the above problems, in the present invention, a group tracking concept is adopted where a plurality of pit strings in the radial direction of an optical disk are grouped, and recognized as one track. The one track is formed by a plurality of pit strings having a size not greater than the optical resolution limit in the radial direction and a size not less than or not greater than the optical resolution limit or only not greater than optical resolution limit in the tangential direction, and reproduction of the super-resolution pit itself is performed by using a thermal non-linear phenomenon generated locally, but, tracking is realized by the method used for existing optical disks (tracking by far field light) where a plurality of strings of pits are considered as one track, and by using the reflected light or the transmitted light from the optical disk, which is detected by moving the readout laser light.

This invention realizes an optical disk with the density increased in the radial direction of the disk without using a guide such as the land/groove or the like, and thus there is an advantage in that the production technique and method used in the existing read-only optical disk can be applied as is. Therefore the disk structure using this technique has an advantage for reducing production cost because the disk is easier to produce. Moreover, because a tracking method using a recorded pit is used, it is possible to realize an increase in the density in the radial direction of the disk, and an improvement in reproduction crosstalk by removing the guide structure of the land/groove so as to widen the recorded pit space, and, therefore, better optical disk characteristics are obtained.

### BRIEF DESCRIPTION OF THE DRAWINGS

FIG. 1 shows a disk pattern of an existing disk.

FIG. 2A shows a single disk pattern according to the present invention.

FIG. 2B shows a random disk pattern according to the present invention.

FIG. 2C shows a multi-valued disk pattern according to the present invention.

FIG. 3 shows calculation values of a tracking error signal in an existing disk configuration and in a disk configuration according to the present invention.

FIG. 4A shows a signal characteristic of a disk according to the present invention.

FIG. 4B shows a temperature distribution in the case where a spot center of a beam is tracking controlled to the center of a pit in three pit strings.

FIG. 5A shows a reproduction signal when offsetting the tracking signal of a disk according to the present invention [the center of the beam spot is on an outside pit string].

FIG. 5B is the same as above [the center of the beam spot is between the center and the outside pit string].

FIG. 5C is the same as above [the center of the beam spot is on the center pit string]

FIG. 6 shows track pitch dependency on a push-pull signal.

FIG. 7 shows a temperature distribution in the case where the spot center of the beam is tracking controlled to one pit in four pit strings.

FIG. 8A shows temperature differences between a pit string in the spot center and an adjacent pit string when the spot center of the beam is controlled to the center of a pit in three pit strings.

FIG. 8B shows temperature differences between a pit string in the spot center and an adjacent pit string for when the spot center of the beam is controlled to one pit in four pit strings.

### BEST MODE FOR CARRYING OUT THE INVENTION

Hereunder is a description of a best mode for carrying out the present invention.

### Embodiment 1

As a method for realizing an optical disk with the density increased in the radial direction of the disk without using a guide, such as a land/groove or the like, a group tracking is used in which one track is composed of a plurality of pit strings.

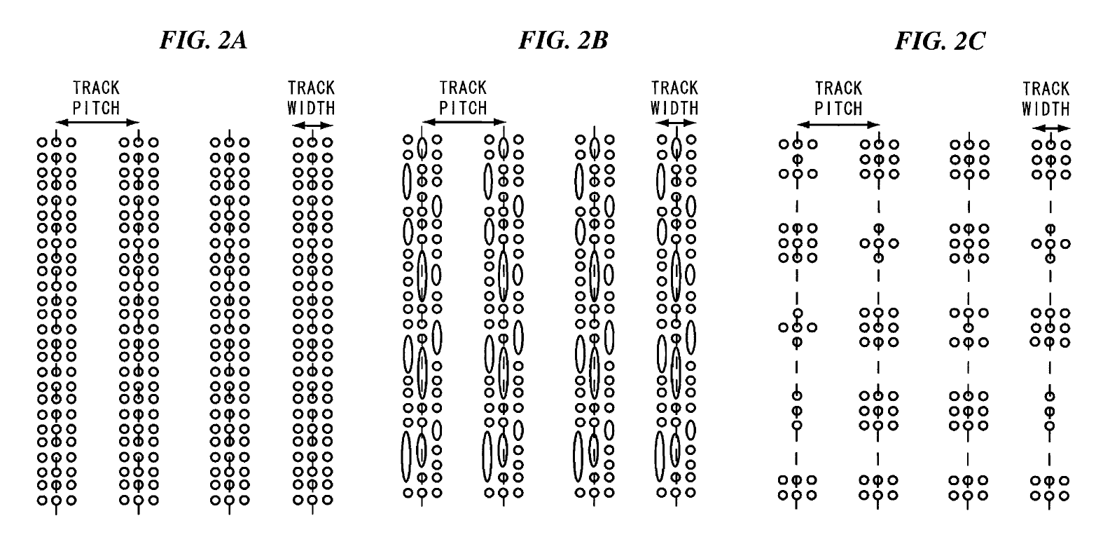

FIG. 2 shows the disk structure of the present invention.

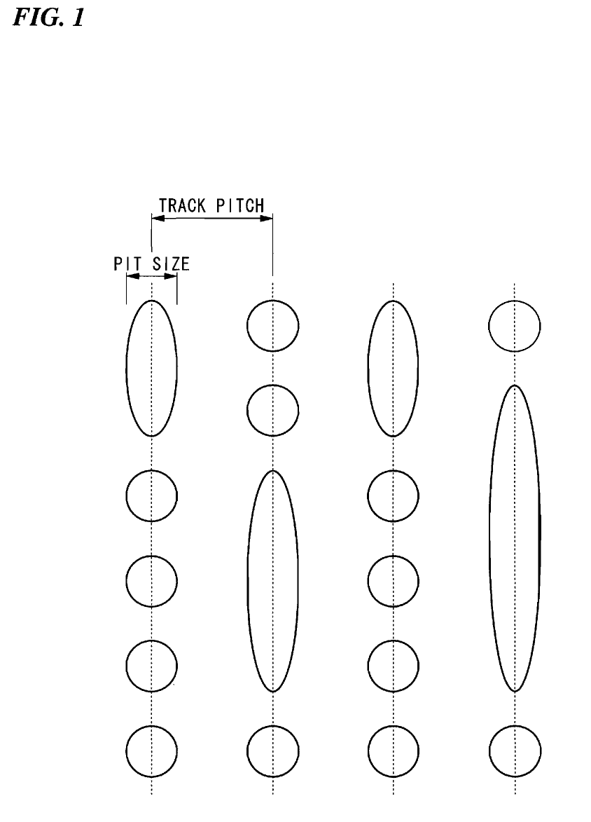

For example, in a structure of a typical optical disk as shown in FIG. 1, when a wavelength (λ): 405 nm, and a numerical aperture (NA): 0.65 are used, the optical resolution limit is defined by λ/(4NA). Therefore the optical resolution limit is 156 nm. The minimum pit size for reproduction needs to be 0.2 μm which is a size of not less than the optical resolution limit, and it is necessary to provide a space of 0.2 μm being a size of not less than the optical resolution limit for tracking control. Therefore the track pitch with the pit and a space combined is 0.4 μm, and the minimum recording pit size is 0.2 μm. Therefore the minimum space between a pit and a pit is approximately 0.2 μm.

However, as shown in FIGS. 2A-2C, in the case of the structure of the optical disk of the present invention, a group tracking is used. The width of the track composed of pits in a plurality of strings is constructed to be 0.2 μm the same as the minimum pit width of the existing track shown in FIG. 1. Furthermore in the case of the structure of the optical disk of the present invention, the width and the space of the track which is the grouped pit strings, are confirmed to be 30% to 200% and 30% to 200% respectively with respect to the spot diameter of the beam for read out. FIG. 2A shows an example where the optical disk is structured with pits of a single size not greater than the optical resolution limit. FIG. 2B shows an example where the optical disk is structured with a random pattern having a pit width of a size not greater than the optical resolution limit in only the radial direction of the optical disk. FIG. 2C shows an example where a pit size group of a size not greater than the optical resolution limit for multi-valued reproduction is combined as one of a size not less than optical resolution limit. It is confirmed that this can be substantiated in the case of FIG. 2A to FIG. 2C.

In the present embodiment, a plurality of pit strings constituting a track are three strings. Furthermore the pit size in the radial direction of an optical disk constituted by a plurality of strings is configured to be not greater than the optical resolution limit.

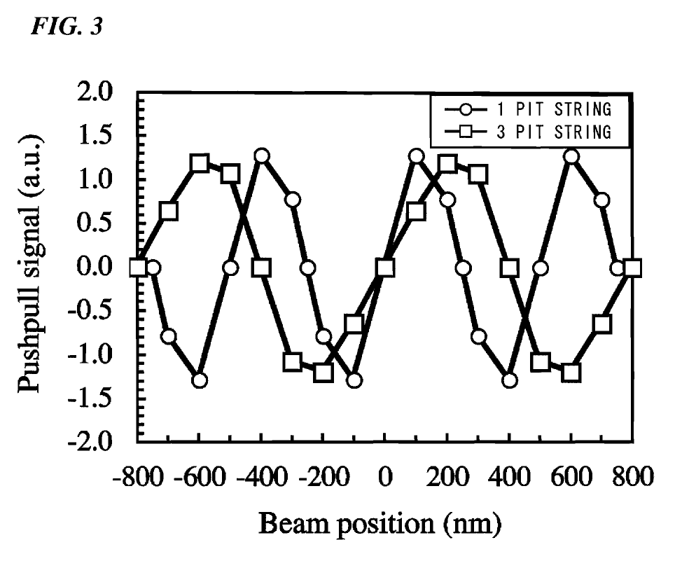

FIG. 3 shows the calculation results for push-pull tracking signals in the case of using an existing disk configuration and a disk configuration of the present invention. The one pit string is for a conventional super-resolution optical disk, and the three pit string is for the super-resolution optical disk developed in the present invention with the density increased in the radial direction.

From FIG. 3, by using a group tracking, pits in a plurality of strings are recognized as a single track, and it indicates that tracking is possible. Moreover regarding the tracking error signal by push-pull, it is calculated that this is almost the same level as for the existing disk structure.

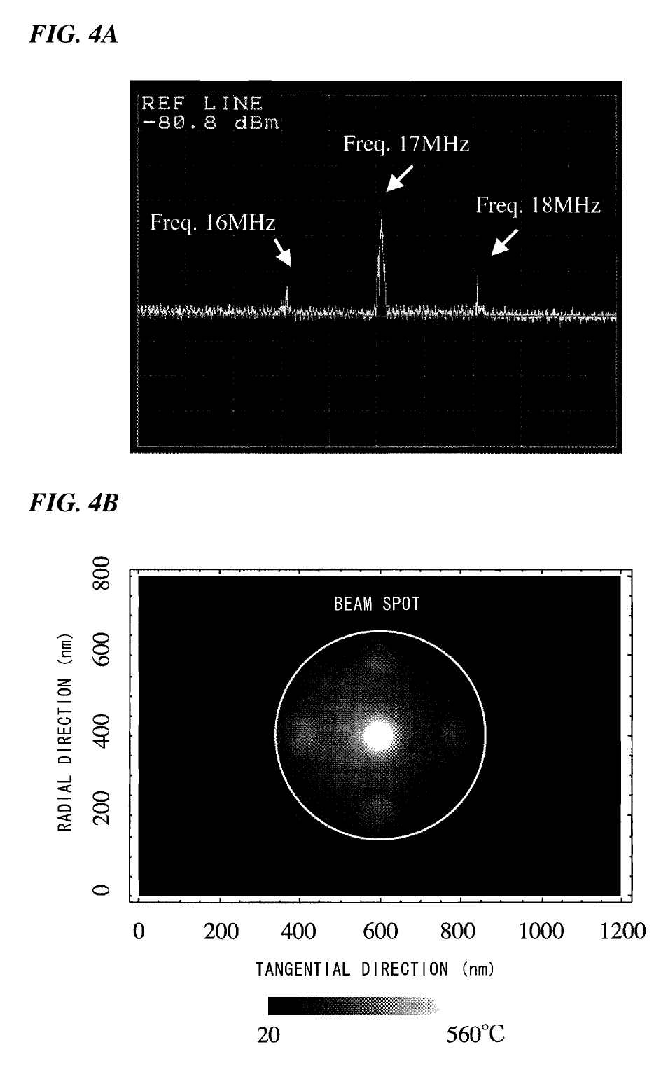

Furthermore FIG. 4A shows an example of a reproduction signal characteristic when using the disk structure of the present invention. An optical disk having a super-resolution functional film recorded with pits of different periods for pits of each of three grouped strings in the disk structure of the present invention is manufactured and reproduced. When the spot center of the beam is tracking controlled to the center of a grouped three pit strings, it is confirmed that a reproduction signal of only the center pit string is obtained.

The localized optical non-linear phenomenon that is used in the super-resolution reproduction of the optical disk structure of the present invention occurs in the high temperature range. FIG. 4B shows a temperature distribution when the spot center of the beam is tracking controlled to the center of the three pit strings. It can be confirmed that an internal temperature of a center pit of the three pit strings is higher than the temperatures of the adjacent pit strings. If the temperature difference between the center pit string and the adjacent pit string is large, then it is possible to reproduce only the center pit string, which is also substantiated by calculation.

Furthermore it is revealed that the signal crosstalk between an optional recorded pit string and the adjacent recorded pit string, is obtained to be approximately less than −30 dB.

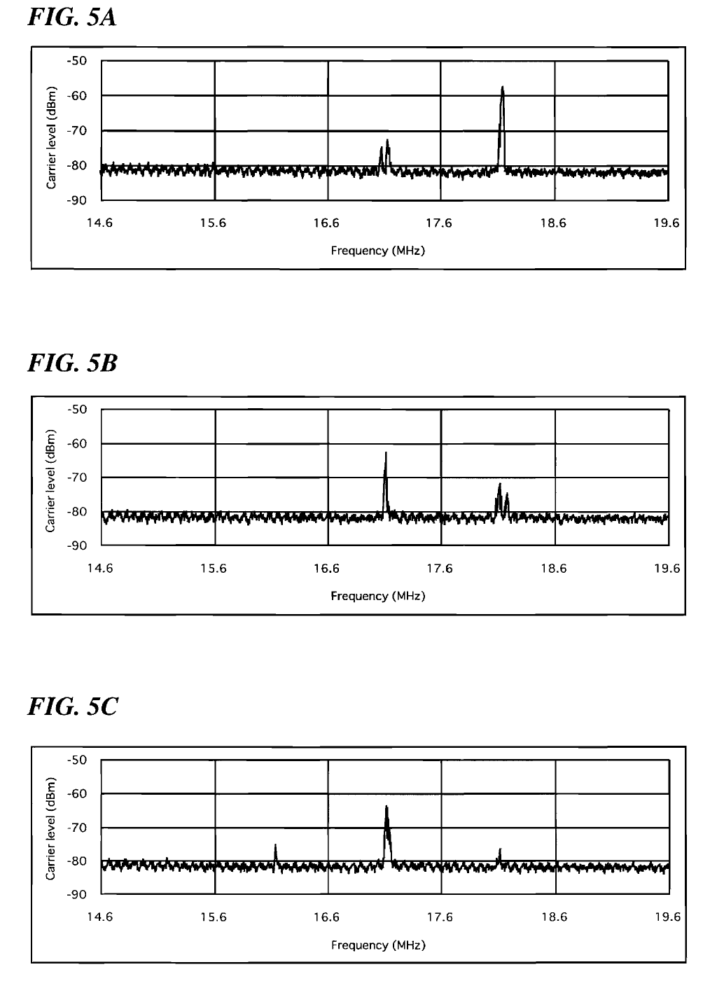

FIG. 5 shows a reproduction signal when the center of a reproduction beam used for reproduction (super-resolution reproduction occurs only in the center) is offset controlled so that tracking control is applied from the outside to the center of the grouped three pit strings. FIG. 5A shows the case where tracking control is performed so that the center of the reproduction beam is positioned on the outside of the grouped three pit strings. FIG. 5B shows the case where tracking control is performed so that the center of the reproduction beam is positioned in between the outside and the center of the grouped three pit strings. FIG. 5C shows the case where tracking control is performed so that the center of the reproduction beam is positioned in the center of the grouped three pit strings. From the examples of FIG. 5A to FIG. 5C, it is confirmed that by performing tracking control so that the center of the beam used for reproduction is positioned on each pit string of the grouped pit strings, it is possible to reproduce pit strings of objective positions.

Furthermore, in the optical disk structure of the present invention, the same effect as for the case of a super-resolution optical disk using a magnetic material is confirmed. Moreover, as shown in FIG. 2C, it is also confirmed to be able to perform multi-valued reproduction by grouping pits having a size of not greater than the optical resolution limit in the previously described group tracking and performing reproduction by using the grouped pits which are recognized as one line of not less than the optical resolution limit.

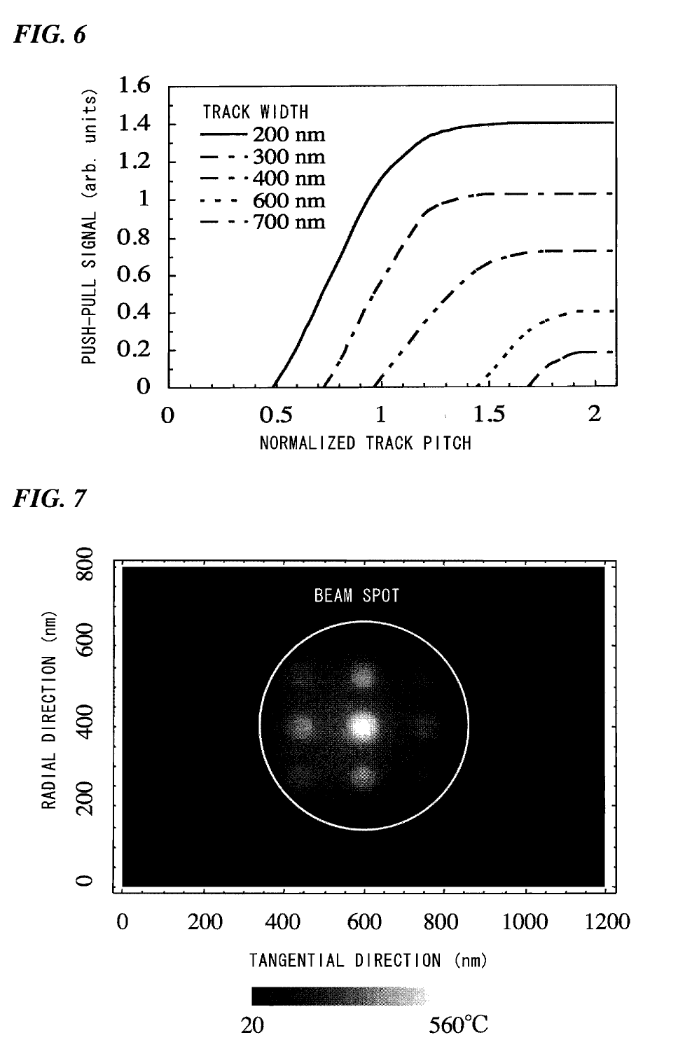

FIG. 6 shows the calculation results of tracking pitch dependency on a push-pull signal in grouped three pit strings. The horizontal axis is the track pitch of the group track and is normalized by the spot diameter. The track width of the grouped pit strings is 200 nm to 700 nm, and is 30% to 110% with respect to the spot diameter of 632 nm. From the results it can be confirmed that a good push-pull signal is obtained with the track width and the space of the grouped pit strings in a range from 30% to 200% with respect to the spot diameter of the beam.

In the optical disk structure of the present invention, it is confirmed that even in the case with four grouped pit strings, it is possible to reproduce an optional pit string by tracking control. FIG. 7 shows a temperature distribution in the case where the spot center of the beam is tracking controlled to one of the pit strings of the four pit string group. Similarly to FIG. 4B for the case of three pit strings, it is seen that the temperature of the interior of the pit of the track string in the spot center is higher than the temperature of the adjacent pit strings. From this result, it is substantiated that also in the case of four pit strings, reproduction signal characteristics as the same as for three pit strings are obtained.

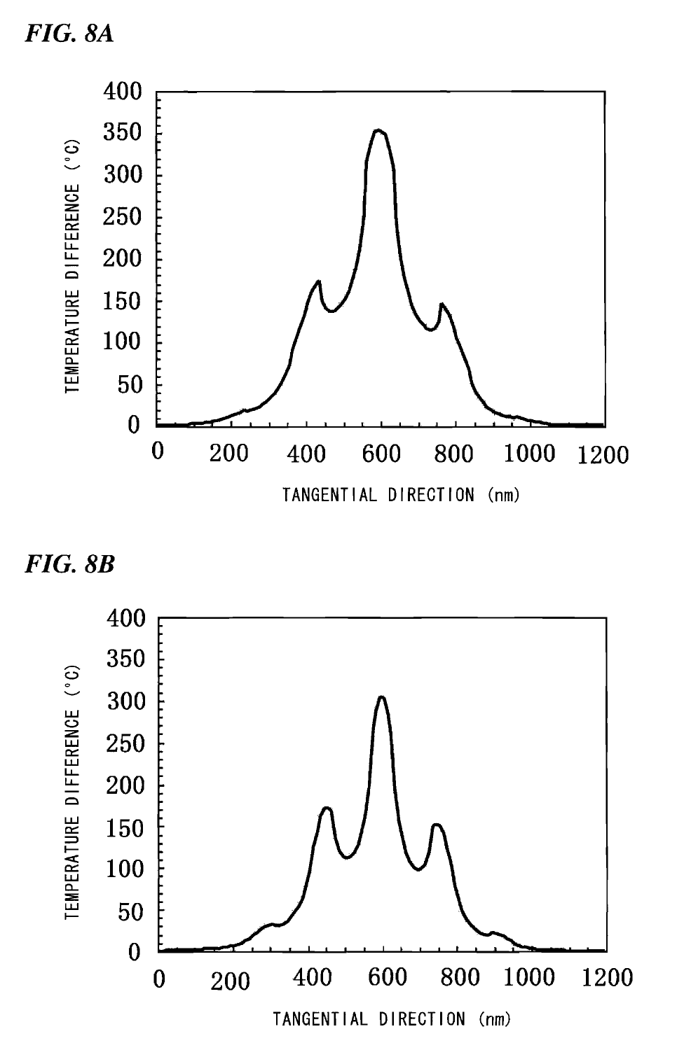

In order to examine the results of FIG. 4B and FIG. 7 in more detail, the temperature difference between the pit string in the spot center and the adjacent pit string is shown in FIG. 8. FIG. 8A and FIG. 8B are the cases for three pit strings and four pit strings respectively. Here a large temperature difference means that the reproduction signal only from a desired readout pit string is obtained, and means that the crosstalk from the adjacent pit string is small. The temperature differences in FIG. 8A and FIG. 8B are substantially the same, and also in the case of four pit strings, it can be confirmed that similar reproduction signal characteristics as for three pit strings is obtained.

1. An optical disk comprising pits formed on a disk substrate in which a land and groove are not formed, all of said pits having a size in a radial direction not greater than an optical resolution limit.

2. The optical disk according to claim 1, wherein said pits have a pit length in a tangential direction not greater than the optical resolution limit, and said optical disk has a functional thin film structure causing super-resolution reproduction using a non linear phenomenon.

3. The optical disk according to claim 1, wherein pit strings are formed by said pits, and said pit strings form a group in the radial direction.

4. The optical disk according to claim 3, wherein a width and a space of a track formed by the grouped pit strings are from 30% to 200% and from 30% to 200% respectively with respect to a spot diameter of a beam for read out.

5. The optical disk according to claim 3, wherein each of said group includes at least two or more pit strings.

6. A control method for an optical disk comprising pits formed on a disk substrate in which a land and groove are not formed, all of said pits having a size in a radial direction not greater than an optical resolution limit, said pits have a pit length in a tangential direction not greater than the optical resolution limit, and said optical disk has a functional thin film structure causing super-resolution reproduction using a non linear phenomenon, pit strings are formed by said pits, and said pit strings form a group in the radial direction, and a width and a space of a track formed by the grouped pit strings are from 30% to 200% and from 30% to 200% respectively with respect to a spot diameter of a beam for read out,
the method comprising detecting degree of movement of a laser light in a radial direction as a change in reflected light or transmitted light intensity, and generating a tracking error signal according to said change.

7. A recording and reproducing method for an optical disk comprising pits formed on a disk substrate in which a land and groove are not formed, all of said pits having a size in a radial direction not greater than an optical resolution limit, said pits have a pit length in a tangential direction not greater than the optical resolution limit, and said optical disk has a functional thin film structure causing super-resolution reproduction using a non linear phenomenon, pit strings are formed by said pits, and said pit strings form a group in the radial direction, and a width and a space of a track formed by the grouped pit strings are from 30% to 200% and from 30% to 200% respectively with respect to a spot diameter of a beam for read out, wherein the tracking control method according to claim 6 is performed, and reproduction using a localized non-linear phenomenon and an optical tracking method are used.

8. A multi-valued reproducing method for an optical disk comprising pits formed on a disk substrate in which a land and groove are not formed, all of said pits having a size in a radial direction not greater than an optical resolution limit, said pits have a pit length in a tangential direction not greater than the optical resolution limit, and said optical disk has a functional thin film structure causing super-resolution reproduction using a non linear phenomenon and pit strings are formed by said pits, and said pit strings form a group in the radial direction, the method comprising performing a tracking control method for the optical disk according to claim 6.
